(19) United States
(12) Patent Application Publication
(10) Pub. No.: US 2025/0260728 A1
(43) Pub. Date: Aug. 14, 2025

(54) METHOD AND APPARATUS FOR UPDATING NETWORK SUPPORT FOR IMS DC CAPABILITY TO UE AFTER INITIAL REGISTRATION IN A WIRELESS COMMUNICATION SYSTEM

(71) Applicant: SAMSUNG ELECTRONICS CO., LTD., Suwon-si, Gyeonggi-do (KR)

(72) Inventor: Ashok Kumar NAYAK, Bangalore (IN)

(21) Appl. No.: 18/862,488

(22) PCT Filed: May 4, 2023
(86) PCT No.: PCT/KR2023/006178

§ 371 Date: Nov. 1, 2024

(30) Foreign Application Priority Data
May 5, 2022 (IN) 202241026216
Apr. 4, 2023 (IN) 202241026216

(51) Int. Cl. H04L 65/1073; H04L 65/1016; H04L 65/1046

(52) U.S. Cl. CPC H04L 65/1073; H04L 65/1016; H04L 65/1046

(57) ABSTRACT

The disclosure relates to a 5G or 6G communication system for supporting a higher data transmission rate. Embodiments herein provide a method for updating IMS DC capability to a UE after an initial registration in a wireless network (1000) by the UE (100). The method includes sending a REGISTRATION request message indicating a UE support for the IMS DC capability to a network apparatus (200). Further, the method includes receiving a REGISTRATION ACCEPT message indicating that the network apparatus does not support the IMS DC capability from network apparatus. Further, the method includes storing the IMS DC capability as not supported in a memory (130) of the UE and discard initiating a DC session with the network apparatus. In an embodiment, method includes receiving an indication from the network apparatus indicating that the network apparatus is enhanced to support for the IMS DC capability, and updating a stored network IMS DC capability from not supported to supported and allow initiating a DC session with the network apparatus.

### TECHNICAL FIELD

Embodiments disclosed herein relate to a wireless communication system (or wireless networks) or a mobile communication system (or, mobile networks). More Specifically, the disclosure relates to a system and a method for updating IP multimedia subsystem (IMS) data channel (DC) capability to a user equipment (UE) after an initial registration in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to provide a method and a system for updating IMS DC capability to a UE after successful initial registration.

Another object of the embodiments herein is to ensure that an IMS network and the UE discovers each other's IMS data channel capabilities before a user starts accessing a service from a network apparatus.

Yet another object of the embodiments herein is to update the IMS DC capability by a network apparatus (i.e., S-CSCF entity) to the registered UEs whenever it (S-CSCF entity which has handled the initial registration for the UE) receives any subsequent request from the UE after the initial registration.

Yet another object of the embodiments herein is to provide the UE that updates UE information about network's IMS DC capability from “not supported” (which the UE received during an initial registration) to “supported” based on the updated received capability from the network apparatus. The proposed method allows the already registered UEs to know the IMS network's DC capability update and hence enabling the registered UEs to make IMS DC session with the network.

### Solution to Problem

According to an embodiment of the disclosure, a method performed by a user equipment (UE) in a wireless communication system is provided. The method comprises: after successful initial registration with a network function, transmitting, to the network function, a first request associated with a subsequent registration; and in case that an internet protocol (IP) multimedia subsystem (IMS) network supports an IMS data channel, receiving, from the network function, a 200 OK response as a response to the first request, the 200 OK response including a Feature-Caps header field indicating the IMS data channel capability.

According to an embodiment of the disclosure, a method performed by a network function in a wireless communication system is provided. The method comprises: after successful initial registration with a user equipment (UE), receiving, from the UE, a first request associated with a subsequent registration; and in case that an internet protocol (IP) multimedia subsystem (IMS) network supports an IMS data channel, transmitting, to the UE, a 200 OK response as a response to the first request, the 200 OK response including a Feature-Caps header field indicating the IMS data channel capability.

According to an embodiment of the disclosure, a user equipment (UE) in a wireless communication system is provided. The UE comprises: a transceiver; and a controller coupled with the transceiver and configured to: after successful initial registration with a network function, transmit, to the network function, a first request associated with a subsequent registration; and in case that an internet protocol (IP) multimedia subsystem (IMS) network supports a IMS data channel, receive, from the network function, a 200 OK response as a response to the first request, the 200 OK response including a Feature-Caps header field indicating the IMS data channel capability.

According to an embodiment of the disclosure, a network function in a wireless communication system, the network function comprising: a transceiver; and a controller coupled with the transceiver and configured to: after successful initial registration with a user equipment (UE), receive, from the UE, a first request associated with a subsequent registration; and in case that an internet protocol (IP) multimedia subsystem (IMS) network supports a IMS data channel, transmit, to the UE, a 200 OK response as a response to the first request, the 200 OK response including a FeatureCaps header field indicating the IMS data channel capability.

Accordingly, the embodiment herein is to provide a method for updating an IMS DC capability to a UE after an initial registration in a wireless network. The method includes sending, by the UE, a REGISTRATION request message indicating a UE support for the IMS DC capability to a network apparatus. Further, the method includes receiving, by the UE, a REGISTRATION ACCEPT message indicating that the network apparatus does not support the IMS DC capability from the network apparatus. Further, the method includes storing, by the UE, the network IMS DC capability as not supported in a memory of the UE and discard initiating a DC session with the network apparatus. In an embodiment, method includes receiving an indication from the network apparatus indicating that the network apparatus is enhanced to support for the IMS DC capability, and updating, by the UE, the stored network IMS DC capability from not supported to supported and allow initiating the DC session with the network apparatus. In another embodiment, method includes sending a request message to the network apparatus to determine whether the network apparatus is enhanced to support for the IMS DC capability, receiving a response message from the network apparatus indicating the network apparatus supports the IMS DC capability, and updating the stored network IMS DC capability from not supported to supported and allow initiating the DC session with the network apparatus.

In an embodiment, the request message includes one of a Re-REGISTRATION request message, a Session Initiation Protocol (SIP) INVITE message and a SIP OPTION request message.

In an embodiment, the response message includes one of a 200 OK response to Re-REGISTRATION request message, a 200 OK response to the SIP INVITE request message and a 200 OK response to the SIP OPTION request message.

In an embodiment, the UE receives the indication in a SIP MESSAGE or a SIP INFO message.

Accordingly, the embodiment herein is to provide a method for updating IMS DC capability to a UE after an initial registration in a wireless network. The method includes receiving, by a network apparatus, a REGISTRATION request message indicating a UE support for the IMS DC capability to a UE. Further, the method includes sending, by the network apparatus, a REGISTRATION ACCEPT message indicating that the network apparatus does not support the IMS DC capability to the UE. Further, the method includes detecting, by the network apparatus, that the network apparatus is enhanced to support for the IMS DC capability. In an embodiment, the method includes receiving a request message from the UE, and sending a response message to the UE indicating that network apparatus supports the IMS DC capability. In another embodiment, the method includes sending an indication from the network apparatus indicating that the network apparatus is enhanced to support for the IMS DC capability.

Accordingly, the embodiment herein is to provide a UE for updating IMS DC capability to the UE after an initial registration in a wireless network. The UE includes an IMS DC controller communicatively connected to a memory and a processor. The IMS DC controller sends a REGISTRATION request message indicating a UE support for the IMS DC capability to a network apparatus. Further, the IMS DC controller receives a REGISTRATION ACCEPT message indicating that the network apparatus does not support the IMS DC capability from the network apparatus. Further, the IMS DC controller stores the network IMS DC capability as not supported in the memory of the UE and discard initiating a DC session with the network apparatus. In an embodiment, the IMS DC controller receives an indication from the network apparatus indicating that the network apparatus is enhanced to support for the IMS DC capability. Further, the IMS DC controller updates the stored network IMS DC capability from not supported to supported and allow initiate the DC session with the network apparatus. In another embodiment, the IMS DC controller sends a request message to the network apparatus to determine whether the network apparatus is enhanced to support for the IMS DC capability. Further, the IMS DC controller receives a response message from the network apparatus indicating the network apparatus supports the IMS DC capability. Further, the IMS DC controller updates the stored network IMS DC capability from not supported to supported and allow initiate the DC session with the network apparatus.

Accordingly, the embodiment herein is to provide a network apparatus for updating IMS DC capability to a UE after an initial registration in a wireless network. The network apparatus includes an IMS DC controller communicatively connected to a memory and a processor. The IMS DC controller receives a REGISTRATION request message indicating a UE support for the IMS DC capability to a UE. Further, the IMS DC controller sends a REGISTRATION ACCEPT message indicating that the network apparatus does not support the IMS DC capability to the UE. Further, the IMS DC controller detects that the network apparatus is enhanced to support for the IMS DC capability. In an embodiment, the IMS DC controller receives a request message from the UE, and sends a response message to the UE indicating that network apparatus supports the IMS DC capability. In another embodiment, the IMS DC controller sends an indication from the network apparatus indicating that the network apparatus is enhanced to support for the IMS DC capability.

These and other aspects of the embodiments herein will be better appreciated and understood when considered in conjunction with the following description and the accompanying drawings. It should be understood that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

According to various embodiments of the disclosure, determining resource based on sidelink in a wireless communication system can be efficiently enhanced.

### BRIEF DESCRIPTION OF DRAWINGS

The method and the wireless network for IMS DC capability update to the UE are illustrated in the accompanying drawings, throughout which like reference letters indicate corresponding parts in the various figures. The embodiments herein will be better understood from the following description with reference to the drawings, in which:

FIG. 1 is a sequence diagram illustrating in which a network apparatus updates a network support for an IMS DC capability to a UE but the UE is not aware of a network capability, according to the prior arts;

FIG. 2 is a sequence diagram illustrating a sequence of events or expected call flow for updating the network support for the IMS DC capability to the UE after initial registration with a network apparatus, according to the embodiments as disclosed herein;

FIG. 3 is a block diagram illustrating various hardware components of the UE, according to the embodiments as disclosed herein;

FIG. 4 is a block diagram illustrating various hardware components of a network apparatus, according to the embodiments as disclosed herein;

FIG. 5 is a flow chart illustrating a method, implemented by the UE, for updating a network support for the IMS DC capability to a UE after initial registration in the wireless network, according to the embodiments as disclosed herein; and

FIG. 6 is a flow chart illustrating a method, implemented by the network apparatus, for updating a network support for the IMS DC capability to a UE after initial registration in the wireless network, according to the embodiments as disclosed herein.

FIG. 7 illustrates a block diagram of a terminal (or a user equipment (UE), according to embodiments of the present disclosure; and

FIG. 8 illustrates a block diagram of a network function according to embodiments of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### Mode for the Invention

Before undertaking the detailed descriptions below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

An IMS is there from long time and almost all big operators have deployed their network to provide various services including a voice over long term evolution (VOLTE) service. The IMS is getting evolved to cater 5th Generation (5G) vertical requirements to offer various new services for which an IMS data channel (DC) is getting used along with a voice call and a video call. The IMS DC helps a various scenario like remote support, remote surgery, remote examination, Augmented reality (AR) with control, Machine Control, virtual reality (VR) with collaboration etc.

A 3GPP service agreement 4 work group (SA4 WG) has determined the IMS DC capability and TS 26.114 has been updated to explain how the IMS DC can be realised.

In Release 18, the 3GPP has created a study item and service agreement 2 (SA2) is analysing the enhancement of IMS architecture to support the IMS DC. In TS 26.114, a key component “Data channel Multimedia Telephony Service for IMS (DCMTSI) client” is defined as a data channel capable MTSI client supporting data channel media. A data channel media function or component is necessary for data channel communication. The TS 26.114 specifies a workflow where a data channel application is created prior to a DCMTSI call where the data channel application is intended to be used. But, the data channel application doesn't cover how to create data channel in parallel with an IMS call setup.

The problem aims to provide enhancement of the IMS network to support the following aspects:
a) How IMS network architecture needs to be enhanced to support functionalities associated with a data channel server functionality allowing for separate control plane and media plane, and data channel application repository. The IMS network architecture includes defining new IMS functionalities and interfaces and/or identifying impacts on existing IMS functionalities and interfaces.
b) Whether, and if so which, existing IMS procedures need to be changed to support the data channel usage in the IMS.
c) Determine how support of data channel capabilities can be discovered by the network apparatus and the UE.
d) Analyse which functionalities and procedures that need to be changed to support policy and charging control for the data channel in the IMS including the QoS support.
e) Whether and how IMS network architecture and procedures can be enhanced to support interworking between a DCMTSI client and MTSI client.
a. The above point has dependency on progress of other points. Coordination with SA4 might be needed.

TR 23.700-87 has listed the key issue (KI). The CR has some proposed solution to discover each other's capability by both the UE and the network apparatus which is when the UE registers with the network apparatus and the UE informs a capability and the network apparatus updates a capability in a 200 OK message of a SIP REGISTER.

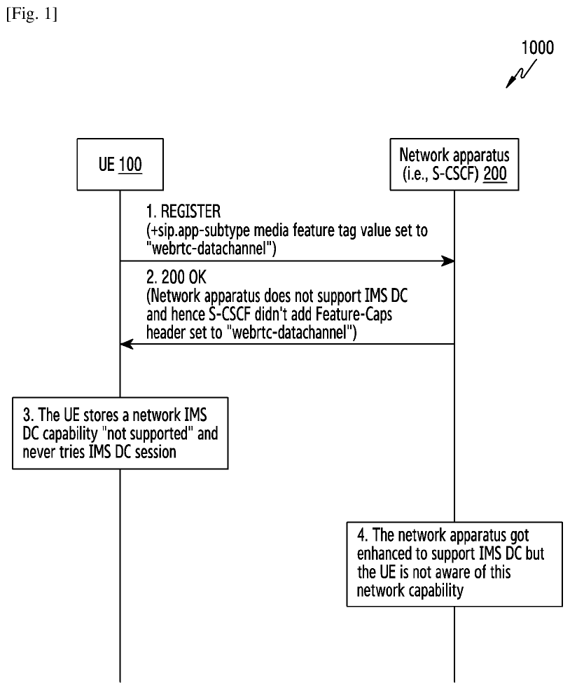

FIG. 1 is a sequence diagram illustrating in which a network apparatus (200) (i.e., (e.g., Serving-Call Session Control Function (S-CSCF) entity)) updates a network support for an IMS DC capability to the UE (100) but the UE (100) is not aware of a network capability, according to the prior arts.

During a registration, the network apparatus (200) does not support the IMS DC and later point of time the network apparatus is enhanced to support the IMS DC. But, the specification does not mention how the capability is sent to the UE (100).

The TR 23.700-87 has proposed that the UE (100) updates an IMS DC capability by adding +sip.app-subtype media feature tag value set to “webrtc-datachannel” while sending a SIP REGISTER. Similarly, when the network apparatus (200) supports the IMS DC then the network apparatus adds the feature-caps header field with a “+g.3gpp.webrtc-datachannel” header field parameter in a 200 OK response message to a SIP REGISTER.

The steps of the FIG. 1 are as follows:
1. Step 1: The UE (100) initiates the SIP REGISTER and provides an IMS DC capability by adding +sip.app-subtype media feature tag with value set to a “webrtc-datachannel”
2. Step 2: The network apparatus (200) sends a 200 OK message to the SIP REGISTER but as the network apparatus (200) does not support IMS DC, the network apparatus (200) does not add a feature-caps header value set to the “webrtc-dat-achannel”
3. Step 3: The UE (100) stores the IMS DC capability to an “not supported” and never adds any IMS data channel related Session Description Protocol (SDP) information while initiating any session with the network apparatus (200).
4. Step 4: Later point of time, the network apparatus (200) is enhanced and started supporting the IMS DC but there is no provision in specification to inform the UE (100). Hence, the UE (100) never able to initiate any IMS DC session even after the network apparatus (200) started supporting.

For clarity purpose, the other node of IMS networks like Proxy Call Session Control Function (P-CSCF), AS, Home Subscriber Server (HSS) is not shown in FIG. 1.

It is desired to address the above mentioned disadvantages or other short comings or at least provide a useful alternative.

Accordingly, the embodiment herein is to provide a method for updating IMS DC capability to a UE after an initial registration in a wireless network. The method includes sending, by the UE, a REGISTRATION request message indicating a UE support for the IMS DC capability to a network apparatus. Further, the method includes receiving, by the UE, a REGISTRATION ACCEPT message indicating that the network apparatus does not support the IMS DC capability from the network apparatus. Further, the method includes storing, by the UE, the network IMS DC capability as not supported in a memory of the UE and discard initiating a DC session with the network apparatus. In an embodiment, method includes receiving an indication from the network apparatus indicating that the network apparatus is enhanced to support for the IMS DC capability, and updating, by the UE, the stored network IMS DC capability from not supported to supported and allow initiating the DC session with the network apparatus. In another embodiment, method includes sending a request message to the network apparatus to determine whether the network apparatus is enhanced to support for the IMS DC capability, receiving a response message from the network apparatus indicating the network apparatus supports the IMS DC capability, and updating the stored network IMS DC capability from not supported to supported and allow initiating the DC session with the network apparatus.

The proposed method can be used to update the IMS DC capability to the UE. The proposed method is used to discover the IMS DC capability by both network and the UE before these services is provided to the UE.

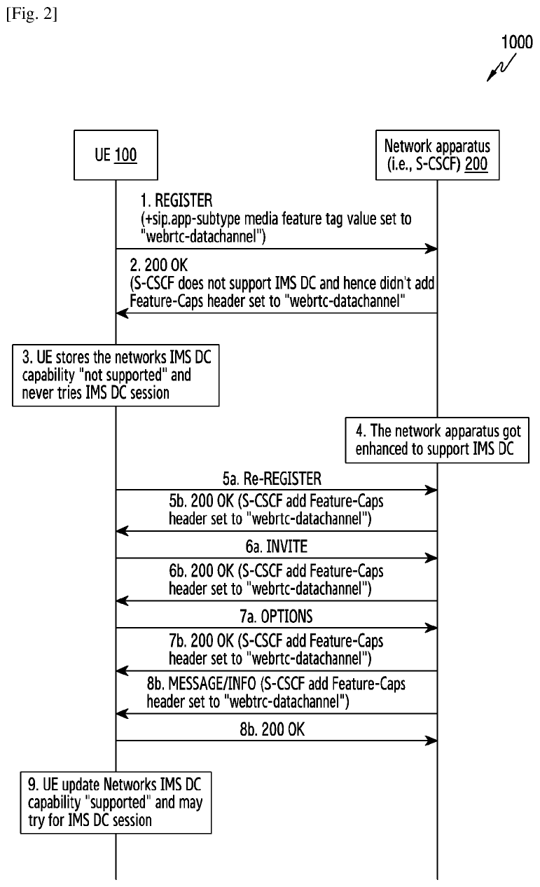

Referring now to the drawings and more particularly to FIGS. 2 through 6, where similar reference characters denote corresponding features consistently throughout the figures, there are shown preferred embodiments.

FIG. 2 is a sequence diagram illustrating a sequence of events or expected call flow for updating the network support for the IMS DC capability to the UE (100) after initial registration with a network apparatus (200), according to the embodiments as disclosed herein.

Referring to the FIG. 2, when the network apparatus (200) does not add the feature-caps header with value “+g.3gpp.webrtc-datachannel as the network apparatus (200) is not supporting the IMS DC then the UE (100) does not send SDP with IMS DC while sending INVITE to make any session with the IMS network. But in latter point of time if the network apparatus (200) starts supporting then:
a) In an embodiment, the network apparatus (200) adds the feature-caps header value set to “+g.3gpp.webrtc-datachannel” in 1xx or 200 OK message of an INVITE message when a request is a first request (receives from the UE (100)) after the network appartus (200) starts to support the IMS DC.
b) In an embodiment, if the UE (100) wants, the UE (100) may add the data channel media descriptions in the SDP offer and retry sending the SIP UPDATE request.
c) In an embodiment, the UE (100) updates the information about network's IMS DC capability from “not supported” which is received during an initial REGISTER to “supported” based on the updated received capability from the network apparatus (200) in 1xx or 200 OK message of the SIP INVITE.
d) In an embodiment, the network apparatus (200) adds the feature-caps header value set to “+g.3gpp.webrtc-datachannel” in a 200 OK message of a re-register received from the UE (100) if the request is the first request, the network apparatus (200) receives from the UE (100) after the wireless network (1000) got enhanced to support the IMS DC.
e) In an embodiment, the network apparatus (200) may update about network's support of IMS DC capability by sending a SIP MESSAGE or SIP INFO or any SIP method by adding the feature-caps header value set to “+g.3gpp.webrtc-datachannel”
f) In an embodiment, the UE (100) sends SIP OPTIONS to query about network's IMS DC capability by updating R-URI set to the network apparatus (200) address and adding +sip.app-subtype media feature tag value set to “webrtc-datachannel”. If the wireless network (1000) supports, the network apparatus (200) can add feature-cap header value set to “+g.3gpp.webrtc-datachannel” in the 200 OK message to the SIP OPTIONS.

The steps of the FIG. 2 are as follows
1. Step 1: the UE (100) initiates the SIP REGISTER and sends the IMS DC capability by adding +sip.app-subtype media feature tag with value set to the “webrtc-datachannel).
2. Step 2: The network apparatus (200) sends the 200 OK message to a SIP REGISTER but as the network apparatus (200) does not support the IMS DC, the network apparatus (200) does not add the feature-caps header value set to “webrtc-datachannel”
3. Step 3: the UE (100) stores the IMS Network's IMS DC capability to “not supported” and never adds any IMS data channel related SDP information while initiating any session with network.
4. Step 4: Later point of time, the network apparatus (200) is enhanced and started supporting the IMS DC. The IMS network is proposed to send the IMS DC capability to the UE (100) in the any subsequent request received from the UE (100).
5. Step 5a: Assuming that, the UE (100) sends Re-REGISTER after certain duration before the EXPIRES of the initial registration.
6. Step 5b: The network apparatus (200) adds the feature-caps header value set to “webrtc-datachannel” in the 200 OK message to the UE's RE-REGISTER request message as the 200 OK message is the first subsequent request received from the network apparatus (200) after the network's IMS DC capability got enhanced.
7. Step 6a: Assuming that the UE (100) intends to make one IMS call by sending INVITE after some time period of the successful initial registration.
8. Step 6b: The network apparatus (200) adds the feature-caps header value set to “webrtc-datachannel” in the 200 OK message (in the 1XX request message) to the UE's INVITE request as the INVITE request is the first subsequent request received from the network apparatus (200) after network's IMS DC capability got enhanced.
9. Step 7a: the UE (100) sends the OPTIONS to the network apparatus (200).
10. Step 7b, the network apparatus (200) sends the 200 OK message (i.e., the network apparatus add the feature-caps header set to “webrtc-datachannel”) to the UE (100).
11. Step 8a, the network apparatus (200) sends the MESSAGE/INFO to the UE (100) (i.e., the network apparatus (200) adds the feature-caps header set to “webrtc-dat-achannel”).
12. Step 8b: the UE (100) sends the OK to the network apparatus (200).
13. Step 9: The UE (100) updates the networks IMS DC capability “supported” and may try for IMS DC session.

In an embodiment, even if the UE (100) does not add the IMS DC capability in the RE-REGISTRATION like the registration had done during initial registration then, the network apparatus (200) adds the feature-caps header value set to “+g.3gpp.webrtc-datachannel” in the 200 OK message of the re-register received from the UE (100) if the request is the first request and the request receives from the UE (100) after the network apparatus (200) got enhanced to support the IMS DC.

In an embodiment, the UE (100) updates the information about network's IMS DC capability from “not supported” which is received during the initial REGISTER to “supported” based on the updated received capability from the network apparatus (200).

For clarity purpose, the other node of IMS networks like Proxy Call Session Control Function (P-CSCF), AS, Home Subscriber Server (HSS) is not shown in FIG. 1 and FIG. 2.

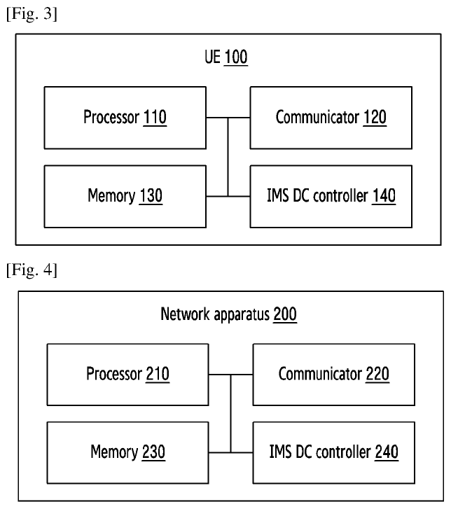

FIG. 3 is a block diagram illustrating various hardware components of the UE (100), according to the embodiments as disclosed herein. In an embodiment, the UE (100) includes a processor (110), a communicator (120), a memory (130) and an IMS DC controller (140). The processor (110) is coupled with the communicator (120), the memory (130) and the IMS DC controller (140).

The IMS DC controller (140) sends the REGISTRATION request message indicating the UE support for the IMS DC capability to the network apparatus (200). Further, the IMS DC controller (140) receives the REGISTRATION ACCEPT message indicating that the network apparatus (200) does not support the IMS DC capability from the network apparatus (200). Further, the IMS DC controller (140) stores the network IMS DC capability as not supported in the memory (130) of the UE (100) and discard initiating a DC session with the network apparatus (200). In an embodiment, the IMS DC controller (140) receives an indication from the network apparatus (200) indicating that the network apparatus (200) is enhanced to support for the IMS DC capability. In an example, IMS DC controller (140) receives the indication in a SIP MESSAGE or a SIP INFO message. Further, the IMS DC controller (140) updates the stored network IMS DC capability from not supported to supported and allows initiate the DC session with the network apparatus (200).

In another embodiment, the IMS DC controller (140) sends a request message to the network apparatus (200) to determine whether the network apparatus (200) is enhanced to support for the IMS DC capability. The request message can be, for example, but not limited to a RE-REGISTRATION request message, a SIP INVITE message and a SIP OPTIONS request message. Further, the IMS DC controller (140) receives the response message from the network apparatus (200) indicating the network apparatus (200) supports the IMS DC capability. The response message can be, for example, but not limited to a 200 OK response to RE-REGISTRATION request message, a 200 OK response to the SIP INVITE request message and a 200 OK response to the SIP OPTION request message. Further, the IMS DC controller (140) updates the stored network IMS DC capability from not supported to supported and allows the UE (100) to initiate the DC session with the network apparatus (200).

The IMS DC controller (140) is implemented by or can include analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) executes instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 4 is a block diagram illustrating various hardware components of the network apparatus (200) (i.e., S-CSCF entity), according to the embodiments as disclosed herein. In an embodiment, the network apparatus (200) includes a processor (210), a communicator (220), a memory (230) and an IMS DC controller (240). The processor (210) is coupled with the communicator (220), the memory (230) and the IMS DC controller (240).

The IMS DC controller (240) receives the REGISTRATION request message indicating the UE support for the IMS DC capability to the UE (100). Further, the IMS DC controller (240) sends the REGISTRATION ACCEPT message indicating that the network apparatus (200) does not support the IMS DC capability to the UE (100). Further, the IMS DC controller (240) detects that the network apparatus (200) is enhanced to support for the IMS DC capability. In an embodiment, the IMS DC controller (240) receives the request message from the UE (100) and sends the response message to the UE (100) indicating that network apparatus (200) supports the IMS DC capability. In another embodiment, the IMS DC controller (240) sends the indication from the network apparatus (200) indicating that the network apparatus (200) is enhanced to support for the IMS DC capability.

The IMS DC controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. The term “non-transitory” should not be interpreted that the memory (230) is non-movable. In certain examples, a non-transitory storage medium may store data that can, over time, change (e.g., in Random Access Memory (RAM) or cache).

Although the FIG. 4 shows various hardware components of the network apparatus (200) but it is to be understood that other embodiments are not limited thereon. In other embodiments, the network apparatus (200) may include less or more number of components. Further, the labels or names of the components are used only for illustrative purpose and does not limit the scope of the invention. One or more components can be combined together to perform same or substantially similar function in the network apparatus (200).

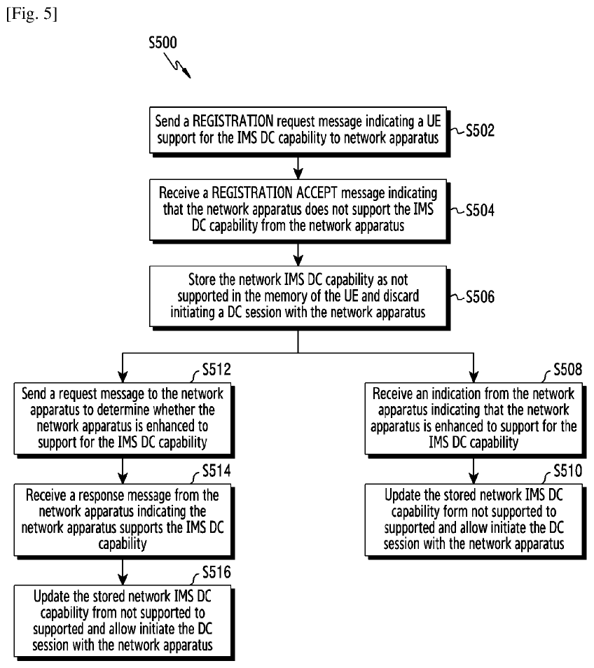

FIG. 5 is a flow chart (S500) illustrating a method, implemented by the UE (100), for updating the network support for the IMS DC capability to the UE (100) after initial registration in the wireless network (1000), according to the embodiments as disclosed herein. The operations (S502-S516) are handled by the IMS DC controller (140).

At S502, the method includes sending the REGISTRATION request message indicating the UE support for the IMS DC capability to the network apparatus (200). At S504, the method includes receiving the REGISTRATION ACCEPT message indicating that the network apparatus (200) does not support the IMS DC capability from the network apparatus (200). At S506, the method includes storing the network IMS DC capability as not supported in the memory (130) of the UE (100) and discard initiating the DC session with the network apparatus (200).

At S508, method includes receiving the indication from the network apparatus (200) indicating that the network apparatus (200) is enhanced to support for the IMS DC capability. At S510, the method includes updating the stored network IMS DC capability from not supported to supported and allow initiating the DC session with the network apparatus (200).

At S512, the method includes sending the request message to the network apparatus to determine whether the network apparatus is enhanced to support for the IMS DC capability. At S514, the method includes receiving the response message from the network apparatus (200) indicating the network apparatus (200) supports the IMS DC capability. At S516, the method includes updating the stored network IMS DC capability from not supported to supported and allow initiating the DC session with the network apparatus (200).

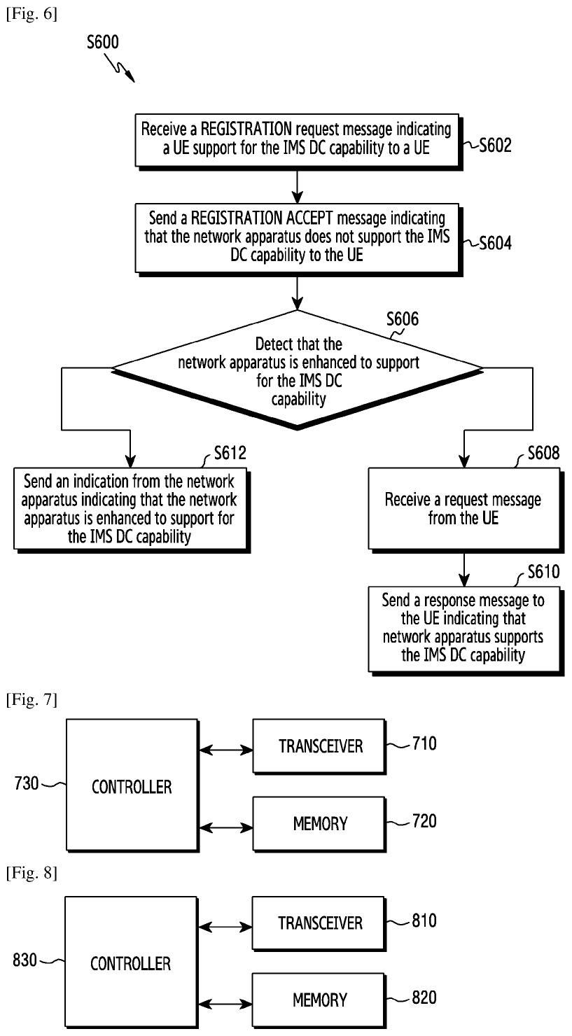

FIG. 6 is a flow chart (S600) illustrating a method, implemented by the network apparatus (200), for updating the network support for the IMS DC capability to the UE (100) after initial registration in the wireless network (1000), according to the embodiments as disclosed herein. The operations (S602-S612) are handled by the IMS DC controller (240).

At S602, the method includes receiving the REGISTRATION request message indicating the UE support for the IMS DC capability to the UE (100). At S604, the method includes sending the REGISTRATION ACCEPT message indicating that the network apparatus (200) does not support the IMS DC capability to the UE (100). At S606, the method includes detecting that the network apparatus (200) is enhanced to support for the IMS DC capability. At S608, the method includes receiving the request message from the UE (100). At S610, the method includes sending the response message to the UE (100) indicating that network apparatus (200) supports the IMS DC capability. At S612, the method includes sending the indication from the network apparatus (200) indicating that the network apparatus (200) is enhanced to support for the IMS DC capability.

FIG. 7 illustrates a block diagram of a terminal (or a user equipment (UE)), according to embodiments of the present disclosure.

As shown in FIG. 7, a terminal according to an embodiment may include a transceiver 710, a memory 720, and a controller 730. The transceiver 710, the memory 720, and the controller 730 of the terminal may operate according to a communication method of the terminal described above. However, the components of the terminal are not limited thereto. For example, the terminal may include more or fewer components than those described in FIG. 7. In addition, the controller 730, the transceiver 710, and the memory 720 may be implemented as a single chip. Also, the controller 730 may include at least one processor. Furthermore, the UE of FIG. 7 corresponds to the UE of the FIG. 3.

The transceiver 710 collectively refers to a terminal station receiver and a terminal transmitter, and may transmit/receive a signal to/from a network function or another terminal. The signal transmitted or received to or from the terminal may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the controller 730, a signal through a wireless channel, and transmit a signal output from the controller 730 through the wireless channel.

The memory 720 may store a program and data required for operations of the terminal. Also, the memory 720 may store control information or data included in a signal obtained by the terminal. The memory 720 may be a storage medium, such as read-only memory (ROM), random access memory (RAM), a hard disk, a CD-ROM, and a DVD, or a combination of storage media.

The controller 730 may control a series of processes such that the terminal operates as described above. For example, the controller 730 may transmit a data signal and/or a control signal to a network function, and the controller 730 may receive a data signal and/or a control signal from a network function.

FIG. 8 illustrates a block diagram of a network function, according to embodiments of the present disclosure.

As shown in FIG. 8 is, the network function of the present disclosure may include a transceiver 810, a memory 820, and a controller 830. The transceiver 810, the memory 820, and the controller 830 of the network function may operate according to a communication method of the network function described above. However, the components of the network function are not limited thereto. For example, the network function may include more or fewer components than those described in FIG. 8. In addition, the controller 830, the transceiver 810, and the memory 820 may be implemented as a single chip. Also, the controller 830 may include at least one processor. Furthermore, the network function of FIG. 8 corresponds to the network apparatus of the FIG. 4.

The transceiver 810 collectively refers to a network function receiver and a network function transmitter, and may transmit/receive a signal to/from a terminal, another network function, and/or a core network function(s) (or entity(s)). The signal transmitted or received to or from the network function may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the controller 830, a signal through a wireless channel, and transmit a signal output from the controller 830 through the wireless channel.

The memory 820 may store a program and data required for operations of the network function. Also, the memory 820 may store control information or data included in a signal obtained by the network function. The memory 820 may be a storage medium, such as ROM, RAM, a hard disk, a CD-ROM, and a DVD, or a combination of storage media.

The controller 830 may control a series of processes such that the network function operates as described above. For example, the controller 830 may receive a data signal and/or a control signal from a terminal, and the controller 830 may transmit a data signal and/or a control signal to a terminal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The proposed method can be used to update the IMS DC capability to the UE (100). The proposed method is used to discover the IMS DC capability by both the network apparatus (200) and the UE (100) before the services are provided to the UE (100).

The various actions, acts, blocks, steps, or the like in the flow charts (S500 and S600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless communication system, the method comprising:
after successful initial registration with a network function, transmitting, to the network function, a first request associated with a subsequent registration; and
in case that an internet protocol (IP) multimedia subsystem (IMS) network supports an IMS data channel, receiving, from the network function, a 200 OK response as a response to the first request, the 200 OK response including a Feature-Caps header field indicating the IMS data channel capability.

2. The method of claim 1,
wherein the network function includes a serving-call session control function (S-CSCF).

3. The method of claim 1, further comprising:
transmitting, to the network function, a second request including an IMS data channel media description in a session description protocol (SDP) offer as a response to the 200 OK response.

4. The method of claim 1,
wherein the initial registration associated with a response from the network function, the response including Feature-Caps header field not indicating the IMS data channel capability.

5. A method performed by a network function in a wireless communication system, the method comprising:
after successful initial registration with a user equipment (UE), receiving, from the UE, a first request associated with a subsequent registration; and
in case that an internet protocol (IP) multimedia subsystem (IMS) network supports an IMS data channel, transmitting, to the UE, a 200 OK response as a response to the first request, the 200 OK response including a Feature-Caps header field indicating the IMS data channel capability.

6. The method of claim 5,
wherein the network function includes a serving-call session control function (S-CSCF).

7. The method of claim 5, further comprising:
receiving, from the UE, a second request including an IMS data channel media description in a session description protocol (SDP) offer as a response to the 200 OK response.

8. A user equipment (UE) in a wireless communication system, the UE comprising:
a transceiver; and
a controller coupled with the transceiver and configured to:
after successful initial registration with a network function, transmit, to the network function, a first request associated with a subsequent registration; and
in case that an internet protocol (IP) multimedia subsystem (IMS) network supports an IMS data channel, receive, from the network function, a 200 OK response as a response to the first request, the 200 OK response including a Feature-Caps header field indicating the IMS data channel capability.

9. The UE of claim 8,
wherein the network function includes a serving-call session control function (S-CSCF).

10. The UE of claim 8, wherein the controller is further configured to:
transmit, to the network function, a second request including an IMS data channel media description in a session description protocol (SDP) offer as a response to the 200 OK response.

11. The UE of claim 8,
wherein the initial registration associated with a response from the network function, the response including Feature-Caps header field not indicating the IMS data channel capability.

12. A network function in a wireless communication system, the network function comprising:
a transceiver; and
a controller coupled with the transceiver and configured to:
after successful initial registration with a user equipment (UE), receive, from the UE, a first request associated with a subsequent registration; and
in case that an internet protocol (IP) multimedia subsystem (IMS) network supports an IMS data channel, transmit, to the UE, a 200 OK response as a response to the first request, the 200 OK response including a Feature-Caps header field indicating the IMS data channel capability.

13. The network function of claim 12,
wherein the network function includes a serving-call session control function (S-CSCF).

14. The network function of claim 12, wherein the controller is further configured to:
receive, from the UE, a second request including an IMS data channel media description in a session description protocol (SDP) offer as a response to the 200 OK response.

15. The network function of claim 12,
wherein the initial registration associated with a response from the network function, the response including Feature-Caps header field not indicating the IMS data channel capability.
